(19) United States
(12) Patent Application Publication
(10) Pub. No.: US 2003/0217279 A1
(43) Pub. Date: Nov. 20, 2003

(54) Method and apparatus for reproducing data

(76) Inventors: Norihiko Fuchigami, Kamakura-shi (JP); Juichi Shikunami, Kanagawa-ken (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/385,660

(22) Filed: Mar. 12, 2003

(30) Foreign Application Priority Data
May 17, 2002 (JP) 2002-142986

(51) Int. Cl. G06F 12/14

(52) U.S. Cl. 713/189; 380/201

(57) ABSTRACT

A data reproducing apparatus includes a memory separate from a recording medium. The memory stores updatable management information indicating an updatable limitation on playback of a content. Data representative of the content are read out from the recording medium. The management information is read out from the memory. A decision is made as to whether playback of the content is permitted or prohibited in response to the management information read out from the memory. When it is decided that playback of the content is permitted, playback of the content represented by the data read out from the recording medium is implemented. The management information in the memory is updated in response to the implemented content playback.

### BACKGROUND OF THE INVENTION

1. Field of the Invention

This invention relates to a method and an apparatus for reproducing data such as audio data, video data, or audio-visual data which have copyrighted contents or playback-limited contents.

2. Description of the Related Art

It is known to sell storage media such as CDs (compact discs), DVDs (digital versatile discs), or video cassettes which store audio data or video data having copyrighted contents. The storage media are also called the package media. For a person who has bought a package medium, there is no limitation on the playback of contents from the package medium. In other words, the cost of the package medium has a portion corresponding to the right to play back the contents an infinite number of times.

Recently, audio data and video data have been distributed via a communication network such as the Internet without using package media. Mostly, audio data and video data are compressed before being distributed. Even in the case where a narrow-band transmission line is used, the distribution of compressed data can be completed in a reasonable length of time.

In most data-distribution systems dispensing with package media, data are stored in a server of a sender. The data can be distributed from the server to users on demand. In the case of data having copyrighted contents, a step of settling accounts is performed upon the distribution of the data or upon the playback of the contents. It is conceivable to discount the contents on the condition that the right to use the contents is limited.

Limitations on the right to use copyrighted contents include limitations on the playback of the contents and limitations on the copying of the contents. The playback-related limitations are of various types as: 1) a limitation on the permission to play back the contents, 2) a limitation on the number of times the contents are played back, 3) a limitation on an accumulated time or a total time for which the contents are played back, and 4) a limitation on a term for which the contents are played back.

1) The playback permission limitation is as follows. In the case where a data distribution side previously records data on a package medium and then sends the package medium to a user side or in the case where a user side downloads data via the Internet and then records the data on a package medium, the playback of the contents of the data is prohibited until the user side obtains from the data distribution side a permission about the playback. A first way of obtaining a permission is to pay a related account. A second way is to get a password for the playback of the contents of the data.

2) According to the playback number-of-times limitation, the playback of the contents is permitted at most a given number of times, for example, five times. It is desirable to prescribe that the playback of the contents which advances to at least a specified percentage (for example, 50%) relative to the total playback time of the contents is counted as the once execution of the complete playback.

3) The accumulated playback time limitation means a limitation on an accumulated time or a total time for which the contents are entirely or partially played back. According to the accumulated playback time limitation, the playback of the contents is permitted for a prescribed time length (for example, 15 minutes).

4) The playback term limitation basically means that the playback of the contents is permitted until the end of a prescribed term or a prescribed time limit (for example, 200X-year 9-month 30-day), and is prohibited thereafter. The prescribed term can be started from the date of the purchase of the contents or the date of the first playback of the contents. The length of the prescribed term can be set to a given number of days, a given number of months, or a given number of weeks. Therefore, according to an example of the playback term limitation, the playback of the contents is permitted for 30 days from the date of the purchase thereof. For example, in the case where the date of the purchase of the contents is 200X-year 9-month 1-day, the playback of the contents is permitted until a date of 200X-year 9-month 30-day.

There is right information (called “usage rules”) for managing the above-mentioned playback permission limitation 1), playback number-of-times limitation 2), accumulated playback time limitation 3), and playback term limitation 4). It is desirable that when data having copyrighted contents are distributed or sent, such right information is distributed or sent together with the data. Also, it is desirable that when data having copyrighted contents are recorded on a recording medium, right information relating to the contents is simultaneously recorded thereon. When the data are read out from the recording medium, the right information can also be read out therefrom. In this case, it is possible to decide whether the playback of the contents is permitted or prohibited by referring to the right information.

A portion of the right information for managing the playback permission limitation, the playback number-of-times limitation, or the accumulated playback time limitation is updated as the contents are played back. Other information relating to the right information is also updated. For example, when a permission to play back the contents is obtained, the portion of the right information for managing the playback permission limitation is updated accordingly. When each playback of the contents is completed, the remaining number of times the playback of the contents is permitted decreases by one so that the portion of the right information for managing the playback number-of-times limitation is updated accordingly. As the contents are played back, a remaining time interval for which the playback of the contents is permitted shortens so that the portion of the right information for managing the accumulated playback time limitation is updated accordingly.

A portion of the right information for managing the playback term limitation is used as follows. A data reproducing apparatus reads out, from a recording medium, not only data having copyrighted contents but also right information relating to the contents. Then, the data reproducing apparatus derives a playback time limit from a portion of the right information for managing the playback term limitation. The data reproducing apparatus includes a calendar device for indicating the present date. The data reproducing apparatus compares the present date indicated by the calendar device with the playback time limit. In the case where the present date is before the playback time limit, the data reproducing apparatus starts playing back the contents. On the other hand, in the case where the present date is after the playback time limit, the data reproducing apparatus fails to play back the contents. It is unnecessary to update the portion of the right information for managing the playback term limitation as the contents are played back.

A common personal computer in a user side can implement the reception of data having copyrighted contents via the Internet, the recording of the data on a recording medium, and the playback of the contents. Generally, the personal computer includes a hard-disk drive and a removable-disk drive which operate on storage media. Therefore, the personal computer can act as a data recording and reproducing apparatus. The personal computer also includes a calendar-added clock (a calendar clock) called a real-time clock which continues to operate even when a main power-supply switch of the personal computer is in its OFF position. Theoretically, the personal computer can process data with the previously-mentioned playback permission limitation 1), playback number-of-times limitation 2), accumulated playback time limitation 3), and playback term limitation 4).

In the case where data having copyrighted contents on which the playback permission limitation, the playback number-of-times limitation, and the accumulated playback time limitation are set are reproduced from a recording medium and then the contents are played back, right information stored in the recording medium and relating to the contents are updated accordingly. Thus, a data reproducing apparatus for handling such data is required to have the function of recording updated right information on a recording medium.

There is an inexpensive playback-only apparatus, that is, a data reproducing apparatus which does not have the function of recording a signal on a recording medium. The playback-only apparatus can not update right information stored in a recording medium. Therefore, regarding data having copyrighted contents on which the playback permission limitation, the playback number-of-times limitation, and the accumulated playback time limitation are set, the playback-only apparatus is incapable of properly handling and updating right information relating to the contents. Accordingly, the right information goes wrong as the playback-only apparatus reproduces the contents.

Copyrighted contents on which the playback permission limitation is set can be suitably played back by the playback-only apparatus provided that a permission to play back the contents is given to the apparatus from a data distribution side each time the playback of the contents is requested. To implement this playback, a user side is required to execute troublesome steps. Furthermore, in the data distribution side, the management of an account relating to a permission to play back the contents tends to be troublesome.

Pre-recorded discs of ROM types are widely spread as package media. Regarding data recorded on such a ROM-type recording medium and having copyrighted contents on which the playback permission limitation, the playback number-of-times limitation, and the accumulated playback time limitation are set, conventional techniques are incapable of updating right information stored in the recording medium and relating to the contents. Accordingly, the right information goes wrong as the conventional techniques play back the contents.

### SUMMARY OF THE INVENTION

It is a first object of this invention to provide a method which can suitably handle copyrighted contents with a playback-related limitation even in the case where the updating of right information stored in a recording medium is difficult.

It is a second object of this invention to provide an apparatus which can suitably handle copyrighted contents with a playback-related limitation even in the case where the updating of right information stored in a recording medium is difficult.

A first aspect of this invention provides an apparatus for reproducing data from a recording medium storing content-representing data representing a content on which a playback-related limitation is set, the recording medium further storing right information, the right information including identification information for the content and playback limitation information representing the playback-related limitation. The apparatus comprises an information storage device being separate from the recording medium and being for storing the identification information for the content and the playback limitation information as management information; first means for reading out the content-representing data and the right information from the recording medium; second means for deciding whether the information storage device currently stores information relating to the content represented by the content-representing data read out from the recording medium by the first means; third means for, when the second means decides that the information storage device does not currently store information relating to the content represented by the content-representing data, storing the right information read out from the recording medium by the first means into the information storage device as the management information; fourth means for reading out the management information from the information storage device; fifth means for deciding whether playback of the content represented by the content-representing data is permitted or prohibited in response to the playback limitation information in the management information read out from the information storage device by the fourth means, and in response to the playback limitation information in the right information read out from the recording medium by the first means; sixth means for, when the fifth means decides that playback of the content represented by the content-representing data is permitted, implementing playback of the content; seventh means for updating the management information read out from the information storage device into updating-resultant management information in response to the implemented playback of the content; and eighth means for storing the updating-resultant management information into the information storage device as new management information.

A second aspect of this invention provides an apparatus for reproducing data from a recording medium storing content-representing data representing a content on which a playback permission limitation is set, the playback permission limitation limiting a permission to play back the content, the recording medium further storing right information, the right information including identification information for the content and playback permission limitation information representing the playback permission limitation. The apparatus comprises an information storage device being separate from the recording medium and being for storing the identification information for the content and the playback permission limitation information as management information; first means for reading out the content-representing data and the right information from the recording medium; second means for deciding whether the information storage device currently stores information relating to the content represented by the content-representing data read out from the recording medium by the first means; third means for, when the second means decides that the information storage device does not currently store information relating to the content represented by the content-representing data, storing the right information read out from the recording medium by the first means into the information storage device as the management information; fourth means for reading out the management information from the information storage device; fifth means for deciding whether playback of the content represented by the content-representing data is permitted or prohibited in response to the playback permission limitation information in the management information read out from the information storage device by the fourth means, and in response to the playback permission limitation information in the right information read out from the recording medium by the first means; sixth means for, when the fifth means decides that playback of the content represented by the content-representing data is permitted, implementing playback of the content; seventh means for, when the fifth means decides that playback of the content represented by the content-representing data is prohibited, obtaining a permission to play back the content; eighth means for implementing playback of the content when the seventh means obtains a permission to play back the content; ninth means for adding, to the management information read out from the information storage device by the fourth means, an information piece representing that the seventh means obtains a permission to play back the content, and thereby updating the management information read out from the information storage device into updating-resultant management information; and tenth means for storing the updating-resultant management information into the information storage device as new management information.

A third aspect of this invention provides an apparatus for reproducing data from a recording medium storing content-representing data representing a content on which a playback number-of-times limitation is set, the playback number-of-times limitation limiting a number of times playback of the content is permitted, the recording medium further storing right information, the right information including identification information for the content and playback number-of-times limitation information representing the playback number-of-times limitation. The apparatus comprises an information storage device being separate from the recording medium and being for storing the identification information for the content and the playback number-of-times limitation information as management information including an information piece representing a remaining number of times playback of the content is permitted; first means for reading out the content-representing data and the right information from the recording medium; second means for deciding whether the information storage device currently stores information relating to the content represented by the content-representing data read out from the recording medium by the first means; third means for, when the second means decides that the information storage device does not currently store information relating to the content represented by the content-representing data, storing the right information read out from the recording medium by the first means into the information storage device as the management information; fourth means for reading out the management information from the information storage device; fifth means for deciding whether playback of the content represented by the content-representing data is permitted or prohibited in response to the playback number-of-times limitation information in the management information read out from the information storage device by the fourth means, and in response to the playback number-of-times limitation information in the right information read out from the recording medium by the first means; sixth means for, when the fifth means decides that playback of the content represented by the content-representing data is permitted, implementing playback of the content; seventh means for, when the sixth means implements playback of the content, decrementing by one the remaining number of times playback of the content is permitted which is represented by the information piece in the management information read out from the information storage device by the fourth means, and thereby updating the management information read out from the information storage device into updating-resultant management information; and eighth means for storing the updating-resultant management information into the information storage device as new management information.

A fourth aspect of this invention provides an apparatus for reproducing data from a recording medium storing content-representing data representing a content on which an accumulated playback time limitation is set, the accumulated playback time limitation limiting an accumulated time for which the content is played back, the recording medium further storing right information, the right information including identification information for the content and accumulated playback time limitation information representing the accumulated playback time limitation. The apparatus comprises an information storage device being separate from the recording medium and being for storing the identification information for the content and the accumulated playback time limitation information as management information including an information piece representing a remaining time interval for which playback of the content is permitted; first means for reading out the content-representing data and the right information from the recording medium; second means for deciding whether the information storage device currently stores information relating to the content represented by the content-representing data read out from the recording medium by the first means; third means for, when the second means decides that the information storage device does not currently store information relating to the content represented by the content-representing data, storing the right information read out from the recording medium by the first means into the information storage device as the management information; fourth means for reading out the management information from the information storage device; fifth means for deciding whether playback of the content represented by the content-representing data is permitted or prohibited in response to the accumulated playback time limitation information in the management information read out from the information storage device by the fourth means, and in response to the accumulated playback time limitation information in the right information read out from the recording medium by the first means; sixth means for, when the fifth means decides that playback of the content represented by the content-representing data is permitted, implementing playback of the content; seventh means for measuring a time length of the content playback by the sixth means; eighth means for terminating the content playback by the sixth means when the time length measured by the seventh means reaches the remaining time interval represented by the information piece in the management information read out from the information storage device by the fourth means; ninth means for, when the eighth means terminates the content playback, subtracting the time length measured by the seventh means from the remaining time interval represented by the information piece in the management information read out from the information storage device by the fourth means, and thereby updating the management information read out from the information storage device into updating-resultant management information; and tenth means for storing the updating-resultant management information into the information storage device as new management information.

A fifth aspect of this invention is based on the first aspect thereof, and provides an apparatus wherein the information storage device includes a non-volatile semiconductor memory.

A sixth aspect of this invention provides a method of reproducing data from a recording medium storing content-representing data representing a content on which a playback-related limitation is set, the recording medium further storing right information, the right information including identification information for the content and playback limitation information representing the playback-related limitation. The method comprises the steps of reading out the content-representing data and the right information from the recording medium; accessing an information storage device being separate from the recording medium and being for storing the identification information for the content and the playback limitation information as management information, and deciding whether the information storage device currently stores information relating to the content represented by the content-representing data read out from the recording medium; when it is decided that the information storage device does not currently store information relating to the content represented by the content-representing data, storing the right information read out from the recording medium into the information storage device as the management information; reading out the management information from the information storage device; deciding whether playback of the content represented by the content-representing data is permitted or prohibited in response to the playback limitation information in the management information read out from the information storage device, and in response to the playback limitation information in the right information read out from the recording medium; when it is decided that playback of the content represented by the content-representing data is permitted, implementing playback of the content; updating the management information read out from the information storage device into updating-resultant management information in response to the implemented playback of the content; and storing the updating-resultant management information into the information storage device as new management information.

A seventh aspect of this invention provides a method of reproducing data from a recording medium storing content-representing data representing a content on which a playback permission limitation is set, the playback permission limitation limiting a permission to play back the content, the recording medium further storing right information, the right information including identification information for the content and playback permission limitation information representing the playback permission limitation. The method comprises the steps of reading out the content-representing data and the right information from the recording medium; accessing an information storage device being separate from the recording medium and being for storing the identification information for the content and the playback permission limitation information as management information, and deciding whether the information storage device currently stores information relating to the content represented by the content-representing data read out from the recording medium; when it is decided that the information storage device does not currently store information relating to the content represented by the content-representing data, storing the right information read out from the recording medium into the information storage device as the management information; reading out the management information from the information storage device; deciding whether playback of the content represented by the content-representing data is permitted or prohibited in response to the playback permission limitation information in the management information read out from the information storage device, and in response to the playback permission limitation information in the right information read out from the recording medium; when it is decided that playback of the content represented by the content-representing data is permitted, implementing playback of the content; when it is decided that playback of the content represented by the content-representing data is prohibited, obtaining a permission to play back the content; implementing playback of the content when a permission to play back the content is obtained; adding, to the management information read out from the information storage device, an information piece representing that a permission to play back the content is obtained, and thereby updating the management information read out from the information storage device into updating-resultant management information; and storing the updating-resultant management information into the information storage device as new management information.

An eighth aspect of this invention provides a method of reproducing data from a recording medium storing content-representing data representing a content on which a playback number-of-times limitation is set, the playback number-of-times limitation limiting a number of times playback of the content is permitted, the recording medium further storing right information, the right information including identification information for the content and playback number-of-times limitation information representing the playback number-of-times limitation. The method comprises the steps of reading out the content-representing data and the right information from the recording medium; accessing an information storage device being separate from the recording medium and being for storing the identification information for the content and the playback number-of-times limitation information as management information including an information piece representing a remaining number of times playback of the content is permitted, and deciding whether the information storage device currently stores information relating to the content represented by the content-representing data read out from the recording medium; when it is decided that the information storage device does not currently store information relating to the content represented by the content-representing data, storing the right information read out from the recording medium into the information storage device as the management information; reading out the management information from the information storage device; deciding whether playback of the content represented by the content-representing data is permitted or prohibited in response to the playback number-of-times limitation information in the management information read out from the information storage device, and in response to the playback number-of-times limitation information in the right information read out from the recording medium; when it is decided that playback of the content represented by the content-representing data is permitted, implementing playback of the content; when playback of the content is implemented, decrementing by one the remaining number of times playback of the content is permitted which is represented by the information piece in the management information read out from the information storage device, and thereby updating the management information read out from the information storage device into updating-resultant management information; and storing the updating-resultant management information into the information storage device as new management information.

A ninth aspect of this invention provides a method of reproducing data from a recording medium storing content-representing data representing a content on which an accumulated playback time limitation is set, the accumulated playback time limitation limiting an accumulated time for which the content is played back, the recording medium further storing right information, the right information including identification information for the content and accumulated playback time limitation information representing the accumulated playback time limitation. The method comprises the steps of reading out the content-representing data and the right information from the recording medium; accessing an information storage device being separate from the recording medium and being for storing the identification information for the content and the accumulated playback time limitation information as management information including an information piece representing a remaining time interval for which playback of the content is permitted, and deciding whether the information storage device currently stores information relating to the content represented by the content-representing data read out from the recording medium; when it is decided that the information storage device does not currently store information relating to the content represented by the content-representing data, storing the right information read out from the recording medium into the information storage device as the management information; reading out the management information from the information storage device; deciding whether playback of the content represented by the content-representing data is permitted or prohibited in response to the accumulated playback time limitation information in the management information read out from the information storage device, and in response to the accumulated playback time limitation information in the right information read out from the recording medium; when it is decided that playback of the content represented by the content-representing data is permitted, implementing playback of the content; measuring a time length of the content playback; terminating the content playback when the measured time length reaches the remaining time interval represented by the information piece in the management information read out from the information storage device; when the content playback is terminated, subtracting the measured time length from the remaining time interval represented by the information piece in the management information read out from the information storage device, and thereby updating the management information read out from the information storage device into updating-resultant management information; and storing the updating-resultant management information into the information storage device as new management information.

A tenth aspect of this invention provides an apparatus comprising a memory separate from a recording medium and storing updatable management information indicating an updatable limitation on playback of a content; first means for reading out data representative of the content from the recording medium; second means for reading out the management information from the memory; third means for deciding whether playback of the content is permitted or prohibited in response to the management information read out from the memory by the second means; fourth means for, when the third means decides that playback of the content is permitted, implementing playback of the content represented by the data read out from the recording medium by the first means; and fifth means for updating the management information in the memory in response to the content playback implemented by the fourth means.

### BRIEF DESCRIPTION OF THE DRAWINGS

FIG. 1 is a block diagram of a prior-art data recording and reproducing apparatus.

FIG. 2 is a block diagram of a data reproducing apparatus according to a first embodiment of this invention.

FIG. 3 is a diagram of an information management table provided in a non-volatile memory in FIG. 2.

FIG. 4 is a flowchart of a first segment of a control program for a main controller in FIG. 2.

FIG. 5 is a flowchart of a second segment of the control program.

FIG. 6 is a flowchart of a segment of a control program for a main controller according to a second embodiment of this invention.

FIG. 7 is a flowchart of a segment of a control program for a main controller according to a third embodiment of this invention.

### DETAILED DESCRIPTION OF THE INVENTION

A prior-art data recording and reproducing apparatus will be explained below for a better understanding of this invention.

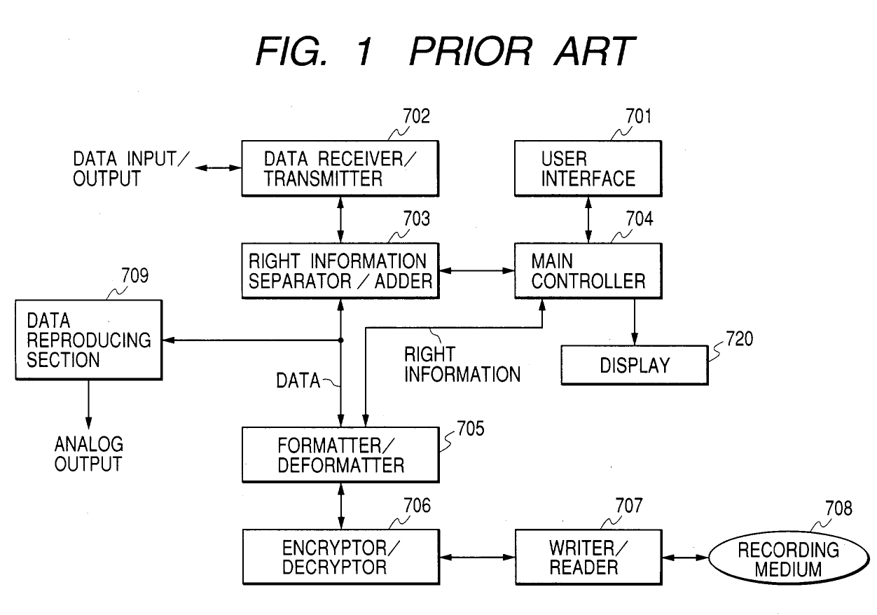

FIG. 1 shows a prior-art apparatus which can operate in either a recording mode or a playback mode (a reproducing mode). The prior-art apparatus of FIG. 1 includes a user interface 701 which can be actuated by a user. When the recording of data is requested, the user actuates the user interface 701 accordingly so that a recording-start command is sent from the user interface 701 to a main controller 704. The main controller 704 starts the recording mode of operation of the apparatus in response to the recording-start command. Specifically, the main controller 704 instructs a data receiver/transmitter 702 to receive data from an external such as the Internet or a digital interface. The data receiver/transmitter 702 sends the received data to a right-information separator/adder 703. The right-information separator/adder 703 divides the received data into right information and contents-representing data. The right-information separator/adder 703 sends the right information to the main controller 704. The main controller 704 analyzes the right information.

After the analyzation of the right information is completed, the main controller 704 sends the right information to a formatter/deformatter 705. The formatter/deformatter 705 converts the right information into a prescribed format to get formatting-resultant right information. The formatter/deformatter 705 sends the formatting-resultant right information to a copyright-protecting encryptor/decryptor 706.

The right-information separator/adder 703 sends the contents-representing data to the formatter/deformatter 705. The formatter/deformatter 705 converts the contents-representing data into the prescribed format to get formatting-resultant contents-representing data. The formatter/deformatter 705 feeds the formatting-resultant contents-representing data to the copyright-protecting encryptor/decryptor 706.

The copyright-protecting encryptor/decryptor 706 encrypts the formatting-resultant contents-representing data according to a prescribed copyright-protecting scheme. The copyright-protecting encryptor/decryptor 706 outputs the encryption-resultant contents-representing data to a writer/reader 707. The copyright-protecting encryptor/decryptor 706 encrypts the formatting-resultant right information according to the prescribed copyright-protecting scheme. The copyright-protecting encryptor/decryptor 706 outputs the encryption-resultant right information to the writer/reader 707. The copyright-protecting encryptor/decryptor 706 may pass the formatting-resultant right information to the writer/reader 707 without processing them. The writer/reader 707 records the contents-representing data and the right information, which are outputted from the copyright-protecting encryptor/decryptor 706, on a recording medium 708.

When the reproduction of data (the playback of contents) is requested, the user actuates the user interface 701 accordingly so that a reproduction-start command is sent from the user interface 701 to the main controller 704. The reproduction-start command includes information for designating or identifying the requested data (the requested contents). The main controller 704 starts the reproducing mode of operation of the apparatus in response to the reproduction-start command. Specifically, the main controller 704 instructs the writer/reader 707 to read out, from a recording medium 708, right information relating to the requested contents. The writer/reader 707 sends the right information to the copyright-protecting encryptor/decryptor 706. When the right information is of an encryption-resultant type, the copyright-protecting encryptor/decryptor 706 decrypts the right information. The copyright-protecting encryptor/decryptor 706 outputs the decryption-resultant right information to the formatter/deformatter 705. When the right information is of a non-encrypted type, the copyright-protecting encryptor/decryptor 706 passes the right information to the formatter/deformatter 705 as it is. The formatter/deformatter 705 converts the right information, which is outputted from the copyright-protecting encryptor/decryptor 706, into an original format to get deformatting-resultant right information. The formatter/deformatter 705 feeds the deformatting-resultant right information to the main controller 704. The main controller 704 analyzes the deformatting-resultant right information. The main controller 704 decides whether the playback of the contents should be permitted or prohibited on the basis of the result of the analyzation of the deformatting-resultant right information.

Specifically, the playback of the contents is permitted in the case where at least one of the following conditions 1), 2), and 3) is satisfied.

1) The playback permission limitation is set on the contents and a permission to play back the contents has already been obtained, or a new permission to play back the contents is obtained at the start of the reproduction of the data.

2) The playback number-of-times limitation is set on the contents, and the remaining number of times the playback of the contents is permitted differs from zero.

3) The accumulated playback time limitation is set on the contents, and the remaining time interval for which the playback of the contents is permitted differs from zero.

In the event that the remaining time interval for which the playback of the contents is permitted becomes zero during the playback of the contents, further playback is inhibited.

When the previously-mentioned conditions 1), 2), and 3) are not satisfied, the playback of the contents is prohibited. In this case, the main controller 704 drives a display 720 to indicate a message “playback not permitted”. Then, the main controller 704 quits the reproducing mode of operation of the apparatus.

In the case where the playback of the contents is permitted, the main controller 704 instructs the writer/reader 707 to read out contents-representing data from the recording medium 708. The writer/reader 707 sends the contents-representing data to the copyright-protecting encryptor/decryptor 706. The copyright-protecting encryptor/decryptor 706 decrypts the contents-representing data. The copyright-protecting encryptor/decryptor 706 outputs the decryption-resultant contents-representing data to the formatter/deformatter 705. The formatter/deformatter 705 converts the contents-representing data into an original format to get deformatting-resultant contents-representing data. The formatter/deformatter 705 sends the deformatting-resultant contents-representing data to a data reproducing section 709. The data reproducing section 709 includes a digital-to-analog converter for changing the deformatting-resultant contents-representing data into a corresponding analog contents-representing signal. The data reproducing section 709 outputs the analog contents-representing signal to an external.

The formatter/deformatter 705 may also send the deformatting-resultant contents-representing data to the right-information separator/adder 703. In this case, the main controller 704 feeds the deformatting-resultant right information to the right-information separator/adder 703. The right-information separator/adder 703 combines the deformatting-resultant contents-representing data and the deformatting-resultant right information into right-information-added data. The right-information separator/adder 703 feeds the right-information-added data to the data receiver/transmitter 702. The data receiver/transmitter 702 outputs the right-information-added data to the external such as the Internet or the digital interface.

When the playback of the contents is completed, the main controller 704 updates the right information as follows. In the case where the playback permission limitation is set on the contents and a new permission to play back the contents is obtained at the start of the reproduction of the data, the main controller 704 updates the right information to indicate that a permission to play back the contents has already been obtained. Regarding the contents on which the playback number-of-times limitation is set, the main controller 704 updates the right information to decrement, by one, the remaining number of times the playback of the contents is permitted. Regarding the contents on which the accumulated playback time limitation is set, the main controller 704 updates the right information to subtract the time length of the present playback from the remaining time interval for which the playback of the contents is permitted. After the updating of the right information is completed, the main controller 704 sends the updating-resultant right information to the writer/reader 707 via the formatter/deformatter 705 and the copyright-protecting encryptor/decryptor 706. The formatter/deformatter 705 and the copyright-protecting encryptor/decryptor 706 process the updating-resultant right information as they do during the recording mode of operation of the apparatus. The writer/reader 707 records the updating-resultant right information over the old right information in the recording medium 708.

In the case where the recording medium 708 is of the ROM type, the prior-art apparatus of FIG. 1 is incapable of updating the right information stored in the recording medium 708. Therefore, the right information goes wrong as the contents are played back.

### First Embodiment

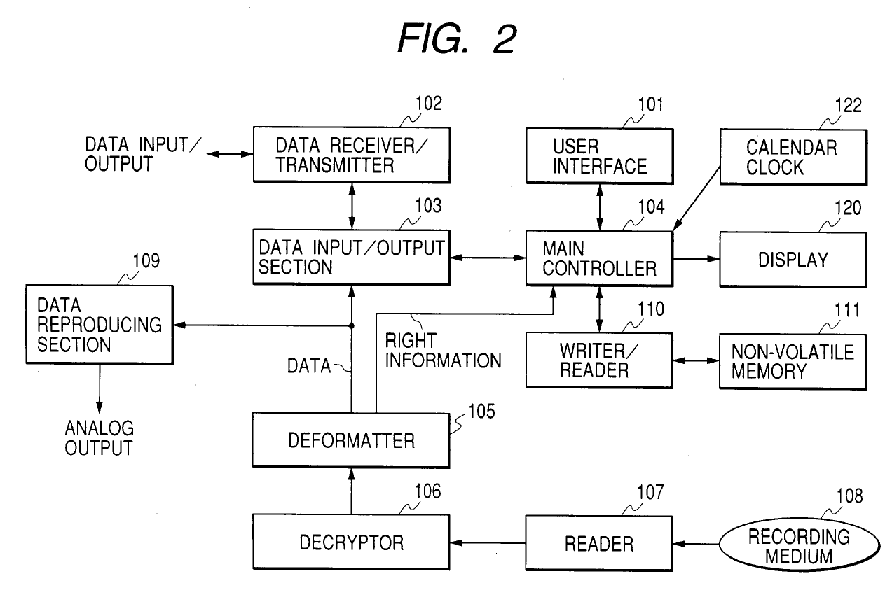

FIG. 2 shows a data reproducing apparatus according to a first embodiment of this invention. With reference to FIG. 2, the data reproducing apparatus includes a user interface 101, a data receiver/transmitter 102, a data input/output section 103, a main controller 104, a deformatter 105, a copyright-protecting decryptor 106, a reader 107, a data reproducing section 109, a writer/reader 110, a non-volatile memory 111, a display 120, and a calendar clock 122. The data reproducing apparatus can be formed by a personal computer.

The user interface 101 can be actuated by a user. The data receiver/transmitter 702 can transmit and receive data to and from an external such as the Internet or a digital interface. The main controller 104 includes a microcomputer, a digital signal processor, or a similar device which has a combination of an input/output port, a processing section, a ROM, and a RAM. The main controller 104 operates in accordance with a control program stored in the ROM or the RAM. The control program is designed to enable the main controller 104 to implement operation steps mentioned later.

The reader 107 can access a recording medium 108 such as a package medium or a removable medium. Examples of the recording medium 108 are an optical disc, a magneto-optical disc, a magnetic disc, and a magnetic tape in a cassette. The reader 107 can read data, information, and signals from the recording medium 108. The writer/reader 110 can access the non-volatile memory 111. The writer/reader 110 can write and read data, information, and signals into and from the non-volatile memory 111. The non-volatile memory 111 is separate from the recording medium 108. The non-volatile memory 111 includes, for example, a semiconductor memory or a flash memory.

The data reproducing apparatus is of a playback-only type. Thus, the data reproducing apparatus does not have the function of recording data, information, and signals on the recording medium 108.

The recording medium 108 stores audio data, video data, or audio-visual data having copyrighted contents or playback-limited contents. Furthermore, the recording medium 108 stores right information relating to the contents. The right information includes ID (identification) signals for the contents respectively. Also, the right information has pieces indicating or concerning playback-related limitations (playback permission limitations, playback number-of-times limitations, and accumulated playback time limitations) on the contents.

The contents-ID signals represent identifiers peculiar to the contents, respectively. For example, each of the contents-ID signals has a portion representative of a country, a portion representative of a copyright holder (a name of a copyrighted-contents producing company), a portion representative of a production date, a data identification information piece, and a sub-information piece. Preferably, data identification information pieces are set for the contents, respectively. The data identification information pieces indicate, for example, tune names. It is preferable to set sub-information pieces peculiar to distributed contents (distributed contents-representing data) respectively. The sub-information pieces indicate, for example, distribution IDs (identifiers) for distributed contents.

At the time of the recording of contents-representing data on a recording medium, a sub-information piece for each of the contents may be generated and be added to a related contents-ID signal.

When the management of the playback-related limitations is implemented, the contents can be identified by referring to the contents-ID signals. Therefore, a permission to play back or a prohibition on the playback is prevented from being given for an unrelated content.

The data reproducing apparatus of FIG. 2 operates as follows. When the reproduction of data (the playback of a content) is requested, the user actuates the user interface 101 accordingly so that a reproduction-start command is sent from the user interface 101 to the main controller 104. The reproduction-start command includes information for designating or identifying the requested data (the requested content). The main controller 104 starts a reproducing mode of operation of the apparatus in response to the reproduction-start command. Specifically, the main controller 104 instructs the reader 107 to read out, from a recording medium 108, right information relating to the requested content. The reader 107 sends the right information to the copyright-protecting decryptor 106. When the right information is of an encryption-resultant type, the copyright-protecting decryptor 106 decrypts the right information. The copyright-protecting decryptor 106 outputs the decryption-resultant right information to the deformatter 105. When the right information is of a non-encrypted type, the copyright-protecting decryptor 106 passes the right information to the deformatter 105 as it is. The deformatter 105 converts the right information, which is outputted from the copyright-protecting decryptor 106, into an original format to get deformatting-resultant right information. The deformatter 105 feeds the deformatting-resultant right information to the main controller 104.

The non-volatile memory 111 previously stores management information in the form of a table. The management information can include ID signals peculiar to respective contents of data stored in the recording medium 108. Also, the management information can include pieces indicating the prescriptions of playback-related limitations on the respective contents.

The main controller 104 instructs the writer/reader 110 to read out the management information (the management information table) from the non-volatile memory 111. The writer/reader 110 feeds the management information to the main controller 104. Preferably, the transfer of the management information from the non-volatile memory 111 to the main controller 104 is executed at the start of the reproducing mode of operation of the apparatus. Alternatively, the transfer of the management information may be executed immediately after a main power-supply switch of the apparatus is changed to its ON position.

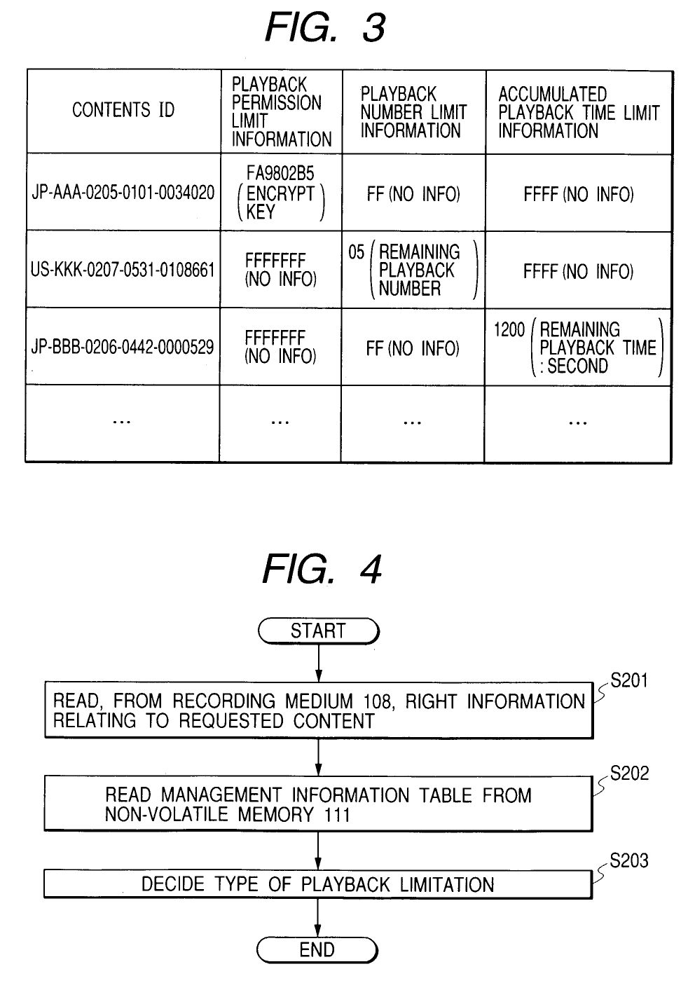

FIG. 3 shows an example of the management information table provided in the non-volatile memory 111. The management information table in FIG. 3 contains ID signals for respective contents which have been played back, and information pieces (playback limitation information pieces) concerning or indicating playback-related limitations on the respective contents. The playback limitation information pieces include information pieces concerning or indicating playback permission limitations on the respective contents, information pieces concerning or indicating playback number-of-times limitations on the respective contents, and information pieces concerning or indicating accumulated playback time limitations on the respective contents. The playback limitation information pieces may further include information pieces concerning or indicating playback term limitations on the respective contents. In FIG. 3, a set of an information piece of a playback permission limitation, an information piece of a playback number-of-times limitation, and an information piece of an accumulated playback time limitation are assigned to each of the contents-ID signals.

The contents-ID signals represent identifiers peculiar to the contents, respectively. The contents can be identified by referring to the contents-ID signals. In FIG. 3, each of the contents-ID signals indicates a set of letters, characters, and numerals. An information piece of each playback permission limitation indicates whether the playback of the related content is permitted or prohibited. In FIG. 3, an information piece of each playback permission limitation which indicates that the playback of the related content is permitted is loaded with a signal of an encryption key. Alternatively, an information piece of each playback permission limitation may be “1” when the playback of the related contents is permitted, and be “0” when the playback of the related contents is prohibited (or the playback of the related contents is not permitted). In FIG. 3, for each content free from a playback permission limitation, a corresponding playback-permission-limitation information piece is in a state corresponding to “no information” (the absence of information). An information piece of each playback number-of-times limitation indicates the remaining number of times the playback of the related content is permitted. In FIG. 3, for each content free from a playback number-of-times limitation, a corresponding playback number-of-times limitation information piece is in a state corresponding to “no information” (the absence of information). An information piece of each accumulated playback time limitation indicates the remaining time interval for which the playback of the related content is permitted. In FIG. 3, for each content free from an accumulated playback time limitation, a corresponding accumulated playback time limitation information piece is in a state corresponding to “no information” (the absence of information).

The contents-ID signals may be of a form different from that in FIG. 3. Also, the playback limitation information pieces may be of forms different from those in FIG. 3. Furthermore, the numbers of letters, characters, and numerals represented by the contents-ID signals and the playback limitation information pieces may differ from those in FIG. 3. The management information table in the non-volatile memory 111 may be encrypted. Specifically, the playback limitation information pieces in the management information table may be encrypted. Also, the contents-ID signals may be encrypted.

With reference back to FIG. 2, the main controller 104 receives the right information from the deformatter 105. The main controller 104 receives the management information (the management information table) from the writer/reader 110. The main controller 104 decides a type of a playback-related limitation on the requested content by referring to the right information. Specifically, the main controller 104 decides which of a playback permission limitation, a playback number-of-times limitation, and an accumulated playback time limitation is set on the requested content. The main controller 104 can detect that the requested content is free from any playback-related limitation. When it is detected that the requested content is free from any playback-related limitation, the main controller 104 acts to implement the playback of the requested content.

The calendar clock 122 indicates the present date. By referring to the right information, the main controller 104 can detect that a playback term limitation is set on the requested content. When it is detected that a playback term limitation is set on the requested content, the main controller 104 gets the present date from the calendar clock 122. The main controller 104 derives, from the right information, a playback time limit on the requested content. The main controller 104 compares the present date with the playback time limit. According to the result of the comparison, the main controller 104 decides whether the playback of the requested content is permitted or prohibited. When the present date is before the playback time limit, the main controller 104 decides that the playback of the requested content is permitted. Then, the main controller 104 acts to execute the playback of the requested content. When the present date is not before the playback time limit, the main controller 104 decides that the playback of the requested content is prohibited. Then, the main controller 104 acts to prohibit the playback of the requested content.

A signal indicating that a permission to play back each content has been obtained can be added to the right information in the recording medium 108. In the case where the main controller 104 decides that a playback permission limitation is set on the requested content, the device 104 refers to the right information and thereby determines whether or not a permission to play back the requested content has been obtained. When a permission to play back the requested content has been obtained, the main controller 104 acts to execute the playback of the requested content.

When a permission to play back the requested content has not yet been obtained, the main controller 104 derives an ID signal for the requested content from the right information. The main controller 104 collates the ID signal for the requested content with ID signals in the management information table, and thereby determines whether or not the same ID signal as that for the requested content exists in the management information table. In the case where the same ID signal as that for the requested content exists in the management information table, the main controller 104 decides that a permission to play back the requested content has already been obtained. Then, the main controller 104 acts to permit and execute the playback of the requested content. When the same ID signal as that for the requested content exists in the management information table, the main controller 104 may determine whether a decryption key for the requested content is present or absent. In the case where the decryption key is present, the main controller 104 acts to permit and execute the playback of the requested content. On the other hand, in the case where the same ID signal as that for the requested content is absent from the management information table or the decryption key is absent, the main controller 104 decides whether or not a permission to play back the requested content can be obtained from the external. Specifically, the main controller 104 tries to establish a connection with the external via the data input/output section 103 and the data receiver/transmitter 102. When it is decided that a permission to play back the requested content can not be obtained, that is, when the establishment of the connection with the external fails, the main controller 104 acts to prohibit the playback of the requested content. In this case, the main controller 104 may drive the display 120 to indicate that the playback of the requested content is prohibited. When it is decided that a permission to play back the requested content can be obtained, that is, when the connection with the external is successfully established, the main controller 104 implements a procedure of obtaining a permission to play back the requested content.

According to a first example of the permission obtaining procedure, the main controller 104 implements an account process for the playback of the requested content with respect to a specified server in a connection destination, and then obtains from the server a permission to play back the requested content. In this case, the main controller 104 can obtain, from the server, not only a permission but also a decryption key (identical with an encryption key) relating to the requested content. According to a second example of the permission obtaining procedure, the main controller 104 drives the display 120 to indicate that the user is required to input a password. The password is inputted via the user interface 101 before being notified to the main controller 104. The main controller 104 communicates with a specified server in a connection destination. During the communication, at least one of the server and the main controller 104 checks whether the password is correct or wrong. Specifically, at least one of the server and the main controller 104 collates the password in question with registered passwords stored in the server. When the password is correct, that is, when the password in question is identical with one of the registered passwords, the main controller 104 obtains from the server a permission to play back the requested content. When the password is wrong, that is, when the password in question is identical with none of the registered passwords, the main controller 104 can not obtain from the server a permission to play back the requested content.

In the case where the main controller 104 successfully obtains a permission to play back the requested content from the external, the main controller 104 adds the ID signal for the requested content and an information piece of the obtained permission to the management information table and thereby updates the table. The information piece of the obtained permission includes, for example, the decryption key (identical with the encryption key). According to the updating-resultant management information table, the main controller 104 acts to execute the playback of the requested content. Then, the main controller 104 instructs the writer/reader 110 to write the updating-resultant management information table over old one in the non-volatile memory 111.

In the case where the main controller 104 fails to obtain a permission to play back the requested content from the external, the device 104 acts to prohibit the playback of the requested content. In this case, the main controller 104 may drive the display 120 to indicate that the playback of the requested content is prohibited.

Preferably, a player ID signal is assigned to the data reproducing apparatus. The player ID signal is stored in, for example, the ROM within the main controller 104. During the permission obtaining procedure, the main controller 104 sends the player ID signal to the server in the connection destination via the data input/output section 103 and the data receiver/transmitter 102. In this case, the server checks whether or not the player ID signal in question is correct, for example, whether or not the player ID signal in question is identical with one of registered player ID signals (predetermined player ID signals). Only when the player ID signal is correct (the player ID signal in question is identical with one of the registered player ID signals), the server gives the data reproducing apparatus (the main controller 104) a permission to play back the requested content. The main controller 104 may instruct the writer/reader 110 to record the player ID signal in the management information table in the non-volatile memory 111.

As previously mentioned, an information piece of a permission to play back a requested content in the recording medium 108 is read out from or written into the non-volatile memory 111. Thus, the data reproducing apparatus of FIG. 2 can properly handle and play back a requested content with a playback permission limitation although the function of recording a signal on a recording medium 108 is absent. Preferably, the non-volatile memory 111 is unremovable and fixed within the data reproducing apparatus. In this case, each apparatus is required to execute a permission obtaining procedure, and the management of permissions to play back contents from the recording medium 108 can be reliably implemented while the illegal playback of the contents can be surely prevented. Once the data reproducing apparatus obtains a permission to play back a requested content, the apparatus can play back the requested content without obtaining a second permission.

The non-volatile memory 111 may be removable from the body of the data reproducing apparatus. In this case, the user can remove not only the recording medium 108 but also the non-volatile memory 111 from a first apparatus, and then carry them. When the removed recording medium 108 and the removed non-volatile memory 111 are placed in a second apparatus (another apparatus), a desired content can be reproduced and played back from the recording medium 108 by the second apparatus.

As previously mentioned, the main controller 104 operates in accordance with a control program stored in its internal ROM or RAM. FIG. 4 is a flowchart of a first segment of the control program which is started by a reproduction-start command sent from the user interface 101 to the main controller 104.

As shown in FIG. 4, a first block S201 of the program segment controls the reader 107 to read out, from a recording medium 108, right information relating to a requested content. The block S201 sends the right information from the reader 107 to the copyright-protecting decryptor 106. When the right information is of an encryption-resultant type, the block S201 controls the copyright-protecting decryptor 106 to decrypt the right information. The block S201 sends the decryption-resultant right information from the copyright-protecting decryptor 106 to the deformatter 105. When the right information is of a non-encrypted type, the block S201 controls the copyright-protecting decryptor 106 to pass the right information to the deformatter 105 as it is. The block S201 controls the deformatter 105 to convert the right information, which is outputted from the copyright-protecting decryptor 106, into an original format to get deformatting-resultant right information. The block S201 sends the deformatting-resultant right information from the deformatter 105 to the main controller 104.

A block S202 following the block S201 instructs the writer/reader 110 to read out management information (a management information table) from the non-volatile memory 111. The block S202 sends the management information from the writer/reader 110 to the main controller 104.

A block S203 subsequent to the block S202 decides a type of a playback-related limitation on the requested content by referring to the right information. Specifically, the block S203 decides which of a playback permission limitation, a playback number-of-times limitation, and an accumulated playback time limitation is set on the requested content. The block S203 detects whether or not the requested content is free from any playback-related limitation. When it is detected that the requested content is free from any playback-related limitation, the block S203 acts to implement the playback of the requested content. The block S203 detects whether or not a playback term limitation is set on the requested content. When it is detected that a playback term limitation is set on the requested content, the block S203 gets the present date from the calendar clock 122. The block S203 derives, from the right information, a playback time limit on the requested content. The block S203 compares the present date with the playback time limit. According to the result of the comparison, the block S203 decides whether the playback of the requested content is permitted or prohibited. When the present date is before the playback time limit, the block S203 decides that the playback of the requested content is permitted. Then, the block S203 acts to execute the playback of the requested content. When the present date is not before the playback time limit, the block S203 decides that the playback of the requested content is prohibited. Then, the block S203 acts to prohibit the playback of the requested content. After the block S203, the current execution cycle of the program segment ends.

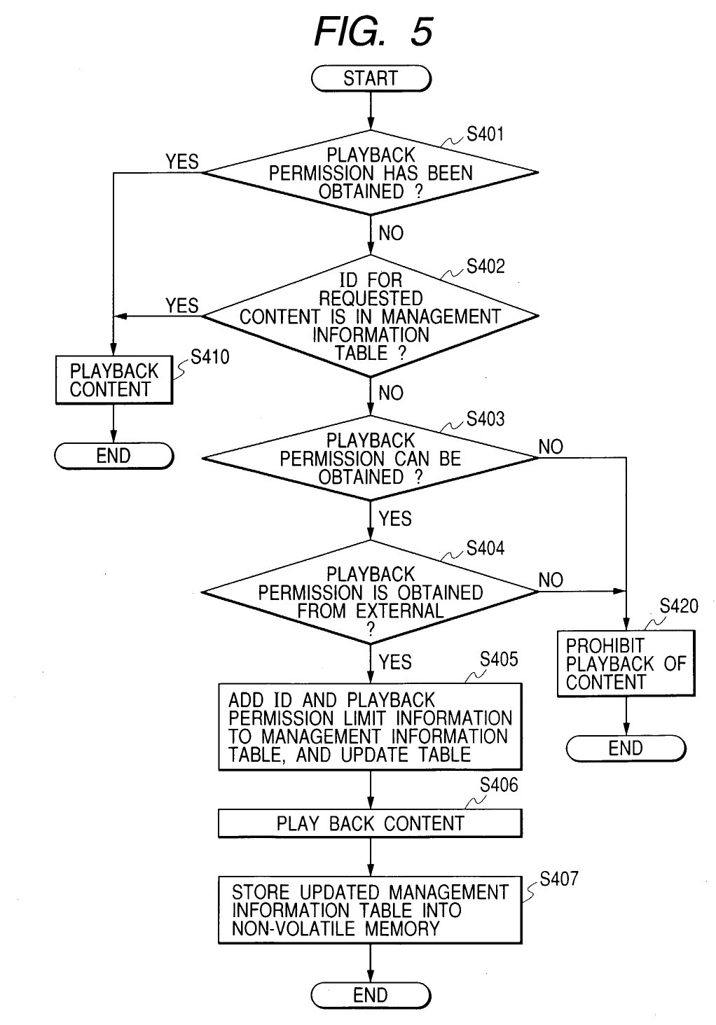

FIG. 5 is a flowchart of a second segment of the control program which is started when the block S203 in FIG. 4 decides that a playback permission limitation is set on the requested content.

As shown in FIG. 5, a first step S401 of the program segment refers to the right information fed from the deformatter 105 and thereby determines whether or not a permission to play back the requested content has been obtained. When a permission to play back the requested content has been obtained, the program advances from the step S401 to a step S410. Otherwise, the program advances from the step S401 to a step S402.

The step S410 implements the playback of the requested content. After the step S410, the current execution cycle of the program segment ends.

The step S402 derives an ID signal for the requested content from the right information. The step S402 collates the ID signal for the requested content with ID signals in the management information table, and thereby determines whether or not the same ID signal as that for the requested content exists in the management information table. In the case where the same ID signal as that for the requested content exists in the management information table, the step S402 decides that a permission to play back the requested content has already been obtained. In this case, the program advances from the step S402 to the step S410 which implements the playback of the requested content. On the other hand, in the case where the same ID signal as that for the requested content is absent from the management information table, the program advances from the step S402 to a step S403.

The step S402 may determine whether a decryption key for the requested content is present or absent when the same ID signal as that for the requested content exists in the management information table. In the case where the decryption key is present, the program advances from the step S402 to the step S410 which implements the playback of the requested content. Otherwise, the program advances from the step S402 to the step S403.

The step S403 decides whether or not a permission to play back the requested content can be obtained from the external. Specifically, the step S403 controls the data input/output section 103 and the data receiver/transmitter 102, and tries to establish a connection with the external therethrough. When it is decided that a permission to play back the requested content can not be obtained, that is, when the establishment of the connection with the external fails, the program advances from the step S403 to a step S420. When it is decided that a permission to play back the requested content can be obtained, that is, when the connection with the external is successfully established, the program advances from the step S403 to a step S404.

The step S420 acts to prohibit the playback of the requested content. The step S420 may drive the display 120 to indicate that the playback of the requested content is prohibited. After the step S420, the current execution cycle of the program segment ends.

The step S404 tries to obtain a permission to play back the requested content from the external. Then, the step S404 decides whether or not the permission has been successfully obtained. When the permission has been successfully obtained, the program advances from the step S404 to a step S405. Otherwise, the program advances from the step S404 to the step S420 which acts to prohibit the playback of the requested content.

A first specific example of the step S404 is as follows. The step S404 controls the data input/output section 103 and the data receiver/transmitter 102 to communicate with a specified server in a connection destination. During the communication, the step S404 implements an account process for the playback of the requested content with respect to the server. When the account process is rejected by the server, the program advances from the step S404 to the step S420. On the other hand, when the account process is accepted by the server, the step S404 obtains from the server a permission to play back the requested content. In this case, the program advances from the step S404 to the step S405. The step S404 can obtain, from the server, not only a permission but also a decryption key (identical with an encryption key) relating to the requested content.

A second specific example of the step S404 is as follows. The step S404 drives the display 120 to indicate that the user is required to input a password. The password is inputted via the user interface 101 before being notified to the main controller 104. The step S404 controls the data input/output section 103 and the data receiver/transmitter 102 to communicate with a specified server in a connection destination. During the communication, at least one of the server and the step S404 checks whether the password is correct or wrong. Specifically, at least one of the server and the step S404 collates the password in question with registered passwords stored in the server. When the password is correct, that is, when the password in question is identical with one of the registered passwords, the step S404 obtains from the server a permission to play back the requested content. In this case, the program advances from the step S404 to the step S405. When the password is wrong, that is, when the password in question is identical with none of the registered passwords, the step S404 can not obtain from the server a permission to play back the requested content. In this case, the program advances from the step S404 to the step S420.

The step S405 adds the ID signal for the requested content and an information piece of the obtained permission to the management information table, and thereby updates the table. The information piece of the obtained permission includes, for example, the decryption key (identical with the encryption key).

A step S406 following the step S405 acts to execute the playback of the requested content according to the updating-resultant management information table.

A step S407 subsequent to the step S406 instructs the writer/reader 110 to write the updating-resultant management information table over old one in the non-volatile memory 111. After the step S407, the current execution cycle of the program segment ends.

### Second Embodiment

A second embodiment of this invention is similar to the first embodiment thereof except for an arrangement mentioned hereafter.

In the case where the main controller 104 decides that a playback number-of-times limitation is set on the requested content, the device 104 refers to the management information table and also the right information. The main controller 104 derives an ID signal for the requested content from the right information. The main controller 104 collates the ID signal for the requested content with ID signals in the management information table, and thereby determines whether or not the same ID signal as that for the requested content exists in the management information table.

When the same ID signal as that for the requested content exists in the management information table, the main controller 104 accesses an information piece in the management information table which concerns the playback number-of-times limitation on the requested content. The main controller 104 gets, from the accessed information piece, the remaining number of times the playback of the requested content is permitted. Then, the main controller 104 decides whether or not the remaining number of times is greater than zero. When the remaining number of times is greater than zero, the main controller 104 acts to execute the playback of the requested content. Otherwise, the main controller 104 acts to prohibit the playback of the requested content. In this case, the main controller 104 may instruct the data input/output section 103 and the data receiver/transmitter 102 to connect with a specified server, and obtain from the server an increased number of times the playback of the requested content is permitted. This process removes the playback number-of-times limitation from the requested content, and hence allows the playback of the requested content.

When the same ID signal as that for the requested content is absent from the management information table, the main controller 104 derives an information piece of the playback number-of-times limitation (the remaining number of times the playback of the requested content is permitted) from the right information. Normally, the right information prescribes a given maximum remaining number of times the playback of the requested content is permitted. Then, the main controller 104 adds the ID signal for the requested content and the information piece of the playback number-of-times limitation to the management information table, and thereby updates the table. Subsequently, the main controller 104 instructs the writer/reader 110 to write the updating-resultant management information table over old one in the non-volatile memory 111. Thus, at the playback of the requested content for the first time, an information piece derived from the right information and indicating the maximum remaining number of times the playback of the requested content is permitted is recorded in the information management table in the non-volatile memory 111. Thereafter, the main controller 104 acts to execute the playback of the requested content.

When the execution of the playback of the requested content has been completed, the main controller 104 accesses the information management table and decrements, by one, the remaining number of times the playback of the requested content is permitted which is indicated by the information piece of the playback number-of-times limitation in the table. Thus, the main controller 104 updates the information piece of the playback number-of-times limitation in the information management table. In other words, the main controller 104 updates the information management table. It is preferable to predetermine that the playback of a specified percentage (for example, 50%) of the requested content is counted as completed playback of the requested content. The specified percentage may be equal to 100%. In the event that the playback of the requested content is compulsorily quit at a playback point less than the specified percentage, the main controller 104 does not update the information piece of the playback number-of-times limitation in the information management table. After the updating of the information management table, the main controller 104 instructs the writer/reader 110 to write the updating-resultant information management table over old one in the non-volatile memory 111.

As previously mentioned, an information piece of a playback number-of-times limitation on a requested content in a recording medium 108 is read out from the non-volatile memory 111. At the playback of the requested content for the first time, an information piece derived from the right information in the recording medium 108 and indicating the maximum remaining number of times the playback of the requested content is permitted is recorded in the information management table in the non-volatile memory 111. Accordingly, the data reproducing apparatus can properly handle and play back a requested content with a playback number-of-times limitation although the function of recording a signal on a recording medium 108 is absent. Preferably, the non-volatile memory 111 is unremovable and fixed within the data reproducing apparatus. In this case, each apparatus is required to keep a playback number-of-times limitation on a requested content in a recording medium 108, and the management of the playback number-of-times limitation on the requested content can be reliably implemented while the illegal playback thereof can be surely prevented.

The non-volatile memory 111 may be removable from the body of the data reproducing apparatus. In this case, the user can remove not only the recording medium 108 but also the non-volatile memory 111 from a first apparatus, and then carry them. When the removed recording medium 108 and the removed non-volatile memory 111 are placed in a second apparatus (another apparatus), a desired content can be reproduced and played back from the recording medium 108 by the second apparatus.

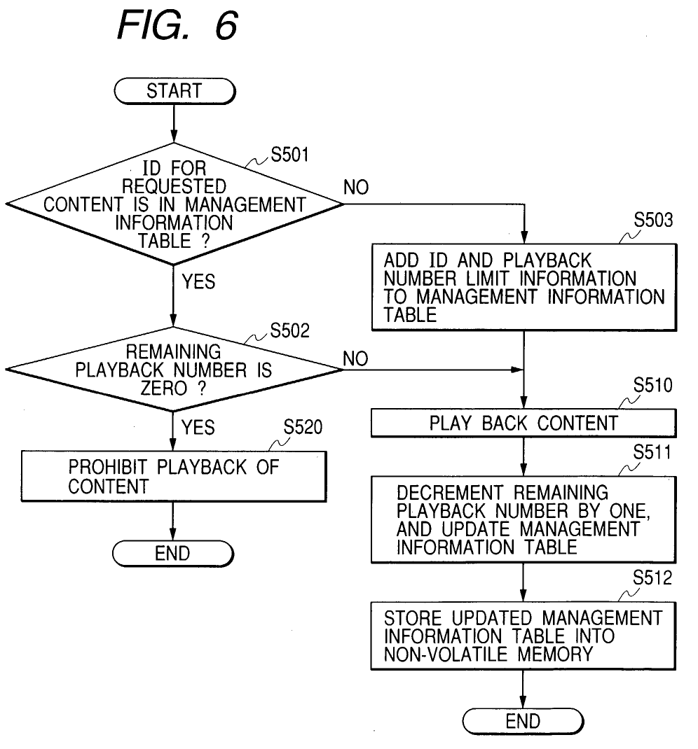

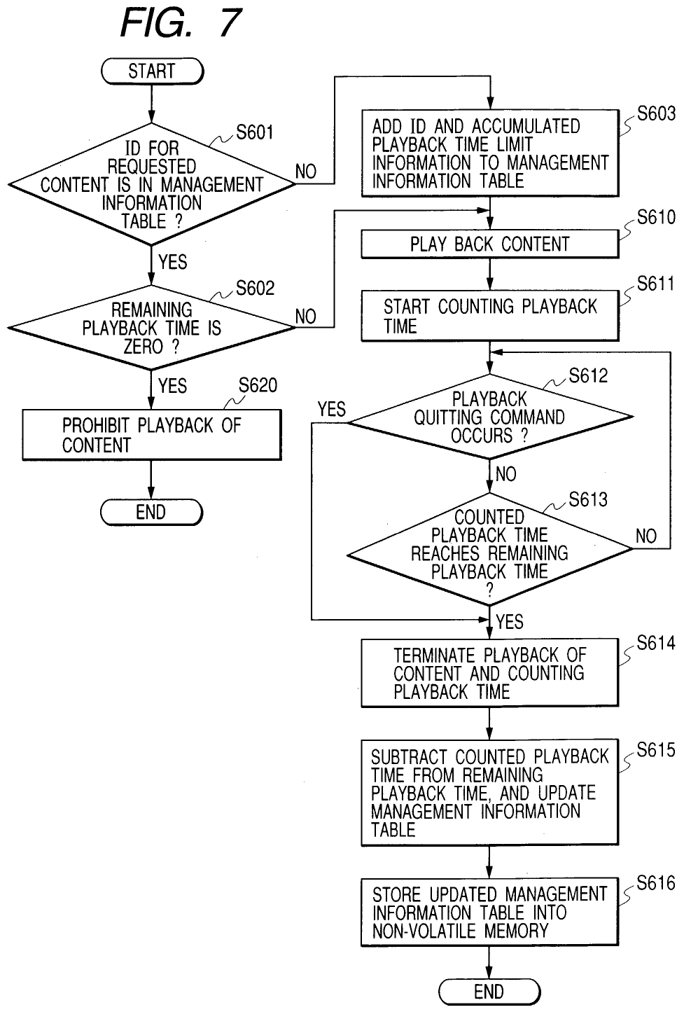

FIG. 6 is a flowchart of a segment of a control program for the main controller 104 which is started when the block S203 in FIG. 4 decides that a playback number-of-times limitation is set on a requested content.

As shown in FIG. 6, a first step S501 of the program segment refers to right information fed from the deformatter 105, and derives an ID signal for the requested content from the right information. The step S501 collates the ID signal for the requested content with ID signals in a management information table fed from the writer/reader 110, and thereby determines whether or not the same ID signal as that for the requested content exists in the management information table. In the case where the same ID signal as that for the requested content exists in the management information table, the program advances from the step S501 to a step S502. Otherwise, the program advances from the step S501 to a step S503.

The step S502 accesses an information piece in the management information table which concerns the playback number-of-times limitation on the requested content. The step S502 gets, from the accessed information piece, the remaining number of times the playback of the requested content is permitted. Then, the step S502 decides whether or not the remaining number of times is greater than zero. When the remaining number of times is greater than zero, the program advances from the step S502 to a step S510. Otherwise, the program advances from the step S502 to a step S520.

The step S510 implements the playback of the requested content. After the step S510, the program advances to a step S511.

The step S520 acts to prohibit the playback of the requested content. In this case, the step S520 may instruct the data input/output section 103 and the data receiver/transmitter 102 to connect with a specified server, and obtain from the server an increased number of times the playback of the requested content is permitted. This process removes the playback number-of-times limitation from the requested content, and hence allows the playback of the requested content. After the step S520, the current execution cycle of the program segment ends.

The step S503 derives an information piece of the playback number-of-times limitation (the remaining number of times the playback of the requested content is permitted) from the right information. Normally, the right information prescribes a given maximum remaining number of times the playback of the requested content is permitted. Then, the step S503 adds the ID signal for the requested content and the information piece of the playback number-of-times limitation to the management information table, and thereby updates the table. Subsequently, the step S503 instructs the writer/reader 110 to write the updating-resultant management information table over old one in the non-volatile memory 111. Thus, at the playback of the requested content for the first time, an information piece derived from the right information and indicating the maximum remaining number of times the playback of the requested content is permitted is recorded in the information management table in the non-volatile memory 111. After the step S503, the program advances to the step S510 which implements the playback of the requested content.

The step S511 which follows the step S510 accesses the information management table and decrements, by one, the remaining number of times the playback of the requested content is permitted which is indicated by the information piece of the playback number-of-times limitation in the table. Thus, the step S511 updates the information piece of the playback number-of-times limitation in the information management table. In other words, the step S511 updates the information management table. It is preferable to predetermine that the playback of a specified percentage (for example, 50%) of the requested content is counted as completed playback of the requested content. The specified percentage may be equal to 100%. In the event that the playback of the requested content is compulsorily quit at a playback point less than the specified percentage, the step S511 does not update the information piece of the playback number-of-times limitation in the information management table.

A step S512 subsequent to the step S511 instructs the writer/reader 110 to write the updating-resultant information management table over old one in the non-volatile memory 111. After the step S512, the current execution cycle of the program segment ends.

### Third Embodiment

A third embodiment of this invention is similar to the first embodiment thereof except for an arrangement mentioned hereafter.

In the case where the main controller 104 decides that an accumulated playback time limitation is set on the requested content, the device 104 refers to the management information table and also the right information. The main controller 104 derives an ID signal for the requested content from the right information. The main controller 104 collates the ID signal for the requested content with ID signals in the management information table, and thereby determines whether or not the same ID signal as that for the requested content exists in the management information table.

When the same ID signal as that for the requested content exists in the management information table, the main controller 104 accesses an information piece in the management information table which concerns the accumulated playback time limitation on the requested content. The main controller 104 gets, from the accessed information piece, the remaining time interval for which the playback of the contents is permitted. Then, the main controller 104 decides whether or not the remaining time interval is longer than zero. Preferably, the remaining time interval is expressed in unit of second. When the remaining time interval is longer than zero, the main controller 104 acts to execute the playback of the requested content. Otherwise, the main controller 104 acts to prohibit the playback of the requested content. In this case, the main controller 104 may instruct the data input/output section 103 and the data receiver/transmitter 102 to connect with a specified server, and obtain from the server an increased remaining time interval for which the playback of the requested content is permitted. This process removes the accumulated playback time limitation from the requested content, and hence allows the playback of the requested content.

When the same ID signal as that for the requested content is absent from the management information table, the main controller 104 derives an information piece of the accumulated playback time limitation (the remaining time interval for which the playback of the contents is permitted) from the right information. Normally, the right information prescribes a given maximum remaining time interval for which the playback of the requested content is permitted. Then, the main controller 104 adds the ID signal for the requested content and the information piece of the accumulated playback time limitation to the management information table, and thereby updates the table. Subsequently, the main controller 104 instructs the writer/reader 110 to write the updating-resultant management information table over old one in the non-volatile memory 111. Thus, at the playback of the requested content for the first time, an information piece derived from the right information and indicating the maximum remaining time interval for which the playback of the requested content is permitted is recorded in the information management table in the non-volatile memory 111. Thereafter, the main controller 104 acts to execute the playback of the requested content.

At the beginning of the playback of the requested content, the main controller 104 starts measuring or counting the playback time length from zero. The measured playback time length (the counted playback time length) corresponds to the present playback of the requested content. When a user desires the playback of the requested content to be compulsorily quit, the user actuates the user interface 101 accordingly so that a playback quitting command is fed from the user interface 101 to the main controller 104. Also, when the playback of the requested content is normally completed, the main controller 104 generates a playback quitting command. Basically, the main controller 104 continues to measure or count the playback time length until there occurs a playback quitting command.

During the playback of the requested content, the main controller 104 continually checks whether or not a playback quitting command occurs. In addition, the main controller 104 continually checks whether or not the measured playback time length (the counted playback time length) reaches the remaining time interval for which the playback of the requested content is permitted. When a playback quitting command occurs or when the measured playback time length reaches the remaining playback time interval, the main controller 104 terminates the playback of the requested content and stops measuring or counting the playback time length.

After the playback of the requested data is terminated, the main controller 104 accesses the information management table and subtracts the measured playback time length (the counted playback time length) from the remaining playback time interval which is indicated by the information piece of the accumulated playback time limitation in the table. Thus, the main controller 104 updates the information piece of the accumulated playback time limitation in the information management table. In other words, the main controller 104 updates the information management table. After the updating of the information management table, the main controller 104 instructs the writer/reader 110 to write the updating-resultant information management table over old one in the non-volatile memory 111.

As previously mentioned, an information piece of an accumulated playback time limitation on a requested content in a recording medium 108 is read out from the non-volatile memory 111. At the playback of the requested content for the first time, an information piece derived from the right information in the recording medium 108 and indicating the maximum remaining time interval for which the playback of the requested content is permitted is recorded in the information management table in the non-volatile memory 111. Accordingly, the data reproducing apparatus can properly handle and play back a requested content with an accumulated playback time limitation although the function of recording a signal on a recording medium 108 is absent. Preferably, the non-volatile memory 111 is unremovable and fixed within the data reproducing apparatus. In this case, each apparatus is required to keep an accumulated playback time limitation on a requested content in a recording medium 108, and the management of the accumulated playback time limitation on the requested content can be reliably implemented while the illegal playback thereof can be surely prevented.

The non-volatile memory 111 may be removable from the body of the data reproducing apparatus. In this case, the user can remove not only the recording medium 108 but also the non-volatile memory 111 from a first apparatus, and then carry them. When the removed recording medium 108 and the removed non-volatile memory 111 are placed in a second apparatus (another apparatus), a desired content can be reproduced and played back from the recording medium 108 by the second apparatus.

FIG. 7 is a flowchart of a segment of a control program for the main controller 104 which is started when the block S203 in FIG. 4 decides that an accumulated playback time limitation is set on a requested content.

As shown in FIG. 7, a first step S601 of the program segment refers to right information fed from the deformatter 105, and derives an ID signal for the requested content from the right information. The step S601 collates the ID signal for the requested content with ID signals in a management information table fed from the writer/reader 110, and thereby determines whether or not the same ID signal as that for the requested content exists in the management information table. In the case where the same ID signal as that for the requested content exists in the management information table, the program advances from the step S601 to a step S602. Otherwise, the program advances from the step S601 to a step S603.

The step S602 accesses an information piece in the management information table which concerns the accumulated playback time limitation on the requested content. The step S602 gets, from the accessed information piece, the remaining time interval for which the playback of the contents is permitted. Then, the step S602 decides whether or not the remaining time interval is longer than zero. When the remaining time interval is longer than zero, the program advances from the step S602 to a step S610. Otherwise, the program advances from the step S602 to a step S620.

The step S610 acts to execute the playback of the requested content. Specifically, the step S610 acts to start the playback of the requested content.

The step S620 acts to prohibit the playback of the requested content. In this case, the step S620 may instruct the data input/output section 103 and the data receiver/transmitter 102 to connect with a specified server, and obtain from the server an increased remaining time interval for which the playback of the requested content is permitted. This process removes the accumulated playback time limitation from the requested content, and hence allows the playback of the requested content. After the step S620, the current execution cycle of the program segment ends.

The step S603 derives an information piece of the accumulated playback time limitation (the remaining time interval for which the playback of the contents is permitted) from the right information. Normally, the right information prescribes a given maximum remaining time interval for which the playback of the requested content is permitted. Then, the step S603 adds the ID signal for the requested content and the information piece of the accumulated playback time limitation to the management information table, and thereby updates the table. Subsequently, the step S603 instructs the writer/reader 110 to write the updating-resultant management information table over old one in the non-volatile memory 111. Thus, at the playback of the requested content for the first time, an information piece derived from the right information and indicating the maximum remaining time interval for which the playback of the requested content is permitted is recorded in the information management table in the non-volatile memory 111. After, the step S603, the program advances to the step S610 which acts to start the playback of the requested content.

A step S611 following the step S610 starts measuring or counting the playback time length from zero. The measured playback time length (the counted playback time length) corresponds to the present playback of the requested content. After the step S611, the program advances to a step S612.

The step S612 checks whether or not a playback quitting command occurs. When a playback quitting command occurs, the program advances from the step S612 to a step S614. Otherwise, the program advances from the step S612 to a step S613.

The step S613 checks whether or not the measured playback time length (the counted playback time length) reaches the remaining time interval for which the playback of the requested content is permitted. When the measured playback time length reaches the remaining playback time interval, the program advances from the step S613 to the step S614. Otherwise, the program returns from the step S613 to the step S612.

The step S614 terminates the playback of the requested content, and stops measuring or counting the playback time length.

A step S615 following the step S614 accesses the information management table and subtracts the measured playback time length (the counted playback time length) from the remaining playback time interval which is indicated by the information piece of the accumulated playback time limitation in the table. Thus, the step S615 updates the information piece of the accumulated playback time limitation in the information management table. In other words, the step S615 updates the information management table.

A step S616 subsequent to the step S615 instructs the writer/reader 110 to write the updating-resultant information management table over old one in the non-volatile memory 111. After the step S616, the current execution cycle of the program segment ends.

### Fourth Embodiment

A fourth embodiment of this invention is similar to one of the first, second, and third embodiments thereof except for a design change mentioned hereafter.

There is a playback-related limitation such that the playback of only a portion (for example, a former 10%) of a requested content is always permitted for a demonstration purpose, and the playback of the whole of the requested content requires the obtainment of a corresponding permission. In the case where a permission to play back the whole of the requested content is obtained, an information piece indicative thereof is stored in the non-volatile memory 111 as a part of the information management table. It is possible to suitably play back the requested content while managing the playback-related limitation thereon.

### Fifth Embodiment

A fifth embodiment of this invention is similar to one of the first, second, third, and fourth embodiments thereof except that the recording medium 108 is of the ROM type.

### Advantages Provided by the Invention

When the playback of a designated content in a recording medium is requested, information indicating a playback-related limitation on the requested content is read out from a non-volatile memory separate from the recording medium. The read-out information is utilized in controlling the playback of the requested content. Accordingly, even a data reproducing apparatus which does not have the function of recording a signal on a recording medium can properly handle and play back a content with a playback-related limitation. After the playback of the requested content, the playback-related limitation on the requested content or the information indicative thereof is updated in accordance with the playback. Therefore, it is possible to surely keep the playback-related limitation.

In the case where a content with a playback-related limitation is fed from a recording medium of the ROM type, the playback-related limitation or information indicative thereof is updated as the content is played back. Therefore, even in this case, it is possible to properly manage and keep the playback-related limitation.

What is claimed is:

1. An apparatus for reproducing data from a recording medium storing content-representing data representing a content on which a playback-related limitation is set, the recording medium further storing right information, the right information including identification information for the content and playback limitation information representing the playback-related limitation, the apparatus comprising:
an information storage device being separate from the recording medium and being for storing the identification information for the content and the playback limitation information as management information;
first means for reading out the content-representing data and the right information from the recording medium;
second means for deciding whether the information storage device currently stores information relating to the content represented by the content-representing data read out from the recording medium by the first means;
third means for, when the second means decides that the information storage device does not currently store information relating to the content represented by the content-representing data, storing the right information read out from the recording medium by the first means into the information storage device as the management information;
fourth means for reading out the management information from the information storage device;
fifth means for deciding whether playback of the content represented by the content-representing data is permitted or prohibited in response to the playback limitation information in the management information read out from the information storage device by the fourth means, and in response to the playback limitation information in the right information read out from the recording medium by the first means;
sixth means for, when the fifth means decides that playback of the content represented by the content-representing data is permitted, implementing playback of the content;
seventh means for updating the management information read out from the information storage device into updating-resultant management information in response to the implemented playback of the content; and
eighth means for storing the updating-resultant management information into the information storage device as new management information.

2. An apparatus for reproducing data from a recording medium storing content-representing data representing a content on which a playback permission limitation is set, the playback permission limitation limiting a permission to play back the content, the recording medium further storing right information, the right information including identification information for the content and playback permission limitation information representing the playback permission limitation, the apparatus comprising:
an information storage device being separate from the recording medium and being for storing the identification information for the content and the playback permission limitation information as management information;
first means for reading out the content-representing data and the right information from the recording medium;
second means for deciding whether the information storage device currently stores information relating to the content represented by the content-representing data read out from the recording medium by the first means;
third means for, when the second means decides that the information storage device does not currently store information relating to the content represented by the content-representing data, storing the right information read out from the recording medium by the first means into the information storage device as the management information;
fourth means for reading out the management information from the information storage device;
fifth means for deciding whether playback of the content represented by the content-representing data is permitted or prohibited in response to the playback permission limitation information in the management information read out from the information storage device by the fourth means, and in response to the playback permission limitation information in the right information read out from the recording medium by the first means;
sixth means for, when the fifth means decides that playback of the content represented by the content-representing data is permitted, implementing playback of the content;
seventh means for, when the fifth means decides that playback of the content represented by the content-representing data is prohibited, obtaining a permission to play back the content;
eighth means for implementing playback of the content when the seventh means obtains a permission to play back the content;
ninth means for adding, to the management information read out from the information storage device by the fourth means, an information piece representing that the seventh means obtains a permission to play back the content, and thereby updating the management information read out from the information storage device into updating-resultant management information; and
tenth means for storing the updating-resultant management information into the information storage device as new management information.

3. An apparatus for reproducing data from a recording medium storing content-representing data representing a content on which a playback number-of-times limitation is set, the playback number-of-times limitation limiting a number of times playback of the content is permitted, the recording medium further storing right information, the right information including identification information for the content and playback number-of-times limitation information representing the playback number-of-times limitation, the apparatus comprising:
an information storage device being separate from the recording medium and being for storing the identification information for the content and the playback number-of-times limitation information as management information including an information piece representing a remaining number of times playback of the content is permitted;
first means for reading out the content-representing data and the right information from the recording medium;
second means for deciding whether the information storage device currently stores information relating to the content represented by the content-representing data read out from the recording medium by the first means;
third means for, when the second means decides that the information storage device does not currently store information relating to the content represented by the content-representing data, storing the right information read out from the recording medium by the first means into the information storage device as the management information;
fourth means for reading out the management information from the information storage device;
fifth means for deciding whether playback of the content represented by the content-representing data is permitted or prohibited in response to the playback number-of-times limitation information in the management information read out from the information storage device by the fourth means, and in response to the playback number-of-times limitation information in the right information read out from the recording medium by the first means;
sixth means for, when the fifth means decides that playback of the content represented by the content-representing data is permitted, implementing playback of the content;
seventh means for, when the sixth means implements playback of the content, decrementing by one the remaining number of times playback of the content is permitted which is represented by the information piece in the management information read out from the information storage device by the fourth means, and thereby updating the management information read out from the information storage device into updating-resultant management information; and
eighth means for storing the updating-resultant management information into the information storage device as new management information.

4. An apparatus for reproducing data from a recording medium storing content-representing data representing a content on which an accumulated playback time limitation is set, the accumulated playback time limitation limiting an accumulated time for which the content is played back, the recording medium further storing right information, the right information including identification information for the content and accumulated playback time limitation information representing the accumulated playback time limitation, the apparatus comprising:
an information storage device being separate from the recording medium and being for storing the identification information for the content and the accumulated playback time limitation information as management information including an information piece representing a remaining time interval for which playback of the content is permitted;
first means for reading out the content-representing data and the right information from the recording medium;
second means for deciding whether the information storage device currently stores information relating to the content represented by the content-representing data read out from the recording medium by the first means;
third means for, when the second means decides that the information storage device does not currently store information relating to the content represented by the content-representing data, storing the right information read out from the recording medium by the first means into the information storage device as the management information;
fourth means for reading out the management information from the information storage device;
fifth means for deciding whether playback of the content represented by the content-representing data is permitted or prohibited in response to the accumulated playback time limitation information in the management information read out from the information storage device by the fourth means, and in response to the accumulated playback time limitation information in the right information read out from the recording medium by the first means;
sixth means for, when the fifth means decides that playback of the content represented by the content-representing data is permitted, implementing playback of the content;
seventh means for measuring a time length of the content playback by the sixth means;
eighth means for terminating the content playback by the sixth means when the time length measured by the seventh means reaches the remaining time interval represented by the information piece in the management information read out from the information storage device by the fourth means;
ninth means for, when the eighth means terminates the content playback, subtracting the time length measured by the seventh means from the remaining time interval represented by the information piece in the management information read out from the information storage device by the fourth means, and thereby updating the management information read out from the information storage device into updating-resultant management information; and
tenth means for storing the updating-resultant management information into the information storage device as new management information.

5. An apparatus as recited in claim 1, wherein the information storage device includes a non-volatile semiconductor memory.

6. A method of reproducing data from a recording medium storing content-representing data representing a content on which a playback-related limitation is set, the recording medium further storing right information, the right information including identification information for the content and playback limitation information representing the playback-related limitation, the method comprising the steps of:
reading out the content-representing data and the right information from the recording medium;
accessing an information storage device being separate from the recording medium and being for storing the identification information for the content and the playback limitation information as management information, and deciding whether the information storage device currently stores information relating to the content represented by the content-representing data read out from the recording medium;
when it is decided that the information storage device does not currently store information relating to the content represented by the content-representing data, storing the right information read out from the recording medium into the information storage device as the management information;
reading out the management information from the information storage device;
deciding whether playback of the content represented by the content-representing data is permitted or prohibited in response to the playback limitation information in the management information read out from the information storage device, and in response to the playback limitation information in the right information read out from the recording medium;
when it is decided that playback of the content represented by the content-representing data is permitted, implementing playback of the content;
updating the management information read out from the information storage device into updating-resultant management information in response to the implemented playback of the content; and
storing the updating-resultant management information into the information storage device as new management information.

7. A method of reproducing data from a recording medium storing content-representing data representing a content on which a playback permission limitation is set, the playback permission limitation limiting a permission to play back the content, the recording medium further storing right information, the right information including identification information for the content and playback permission limitation information representing the playback permission limitation, the method comprising the steps of:
reading out the content-representing data and the right information from the recording medium;
accessing an information storage device being separate from the recording medium and being for storing the identification information for the content and the playback permission limitation information as management information, and deciding whether the information storage device currently stores information relating to the content represented by the content-representing data read out from the recording medium;
when it is decided that the information storage device does not currently store information relating to the content represented by the content-representing data, storing the right information read out from the recording medium into the information storage device as the management information;
reading out the management information from the information storage device;
deciding whether playback of the content represented by the content-representing data is permitted or prohibited in response to the playback permission limitation information in the management information read out from the information storage device, and in response to the playback permission limitation information in the right information read out from the recording medium;
when it is decided that playback of the content represented by the content-representing data is permitted, implementing playback of the content;
when it is decided that playback of the content represented by the content-representing data is prohibited, obtaining a permission to play back the content;
implementing playback of the content when a permission to play back the content is obtained;
adding, to the management information read out from the information storage device, an information piece representing that a permission to play back the content is obtained, and thereby updating the management information read out from the information storage device into updating-resultant management information; and
storing the updating-resultant management information into the information storage device as new management information.

8. A method of reproducing data from a recording medium storing content-representing data representing a content on which a playback number-of-times limitation is set, the playback number-of-times limitation limiting a number of times playback of the content is permitted, the recording medium further storing right information, the right information including identification information for the content and playback number-of-times limitation information representing the playback number-of-times limitation, the method comprising the steps of:
reading out the content-representing data and the right information from the recording medium;
accessing an information storage device being separate from the recording medium and being for storing the identification information for the content and the playback number-of-times limitation information as management information including an information piece representing a remaining number of times playback of the content is permitted, and deciding whether the information storage device currently stores information relating to the content represented by the content-representing data read out from the recording medium;
when it is decided that the information storage device does not currently store information relating to the content represented by the content-representing data, storing the right information read out from the recording medium into the information storage device as the management information;
reading out the management information from the information storage device;
deciding whether playback of the content represented by the content-representing data is permitted or prohibited in response to the playback number-of-times limitation information in the management information read out from the information storage device, and in response to the playback number-of-times limitation information in the right information read out from the recording medium;
when it is decided that playback of the content represented by the content-representing data is permitted, implementing playback of the content;
when playback of the content is implemented, decrementing by one the remaining number of times playback of the content is permitted which is represented by the information piece in the management information read out from the information storage device, and thereby updating the management information read out from the information storage device into updating-resultant management information; and
storing the updating-resultant management information into the information storage device as new management information.

9. A method of reproducing data from a recording medium storing content-representing data representing a content on which an accumulated playback time limitation is set, the accumulated playback time limitation limiting an accumulated time for which the content is played back, the recording medium further storing right information, the right information including identification information for the content and accumulated playback time limitation information representing the accumulated playback time limitation, the method comprising the steps of:
reading out the content-representing data and the right information from the recording medium;
accessing an information storage device being separate from the recording medium and being for storing the identification information for the content and the accumulated playback time limitation information as management information including an information piece representing a remaining time interval for which playback of the content is permitted, and deciding whether the information storage device currently stores information relating to the content represented by the content-representing data read out from the recording medium;
when it is decided that the information storage device does not currently store information relating to the content represented by the content-representing data, storing the right information read out from the recording medium into the information storage device as the management information;
reading out the management information from the information storage device;
deciding whether playback of the content represented by the content-representing data is permitted or prohibited in response to the accumulated playback time limitation information in the management information read out from the information storage device, and in response to the accumulated playback time limitation information in the right information read out from the recording medium;
when it is decided that playback of the content represented by the content-representing data is permitted, implementing playback of the content;
measuring a time length of the content playback;
terminating the content playback when the measured time length reaches the remaining time interval represented by the information piece in the management information read out from the information storage device;
when the content playback is terminated, subtracting the measured time length from the remaining time interval represented by the information piece in the management information read out from the information storage device, and thereby updating the management information read out from the information storage device into updating-resultant management information; and
storing the updating-resultant management information into the information storage device as new management information.

10. An apparatus comprising:
a memory separate from a recording medium and storing updatable management information indicating an updatable limitation on playback of a content;
first means for reading out data representative of the content from the recording medium;
second means for reading out the management information from the memory;
third means for deciding whether playback of the content is permitted or prohibited in response to the management information read out from the memory by the second means;
fourth means for, when the third means decides that playback of the content is permitted, implementing playback of the content represented by the data read out from the recording medium by the first means; and
fifth means for updating the management information in the memory in response to the content playback implemented by the fourth means.
